(19) United States
(12) Patent Application Publication
(10) Pub. No.: US 2015/0316171 A1
(43) Pub. Date: Nov. 5, 2015

(54) HYDRAULIC CONTROL VALVE WITH MANUAL OVERRIDE

(71) Applicant: Parker-Hannifin Corporation, Cleveland, OH (US)

(72) Inventor: Joshua Matthew Guarino, Strongsville, OH (US)

(21) Appl. No.: 14/701,179

(22) Filed: Apr. 30, 2015

Related U.S. Application Data
(60) Provisional application No. 61/986,198, filed on Apr. 30, 2014.

(51) Int. Cl. F16K 31/60; F16K 31/50

(52) U.S. Cl. CPC F16K 31/60; F16K 31/50

(57) ABSTRACT

A manual override for a hydraulic control valve spool includes a rotatable shaft having a threaded hole; a lever pin having a first end connected for movement with a hydraulic control valve spool and a second end having an external thread that is threadably received in the threaded hole; and the threaded hole and external thread include a mechanical antirotation element.

### RELATED APPLICATIONS

This application claims the benefit of U.S. Provisional Application No. 61/986,198 filed Apr. 30, 2014, which is hereby incorporated herein by reference.

### FIELD OF INVENTION

The present invention relates generally to a fluid control valve, and more particularly to a hydraulic control valve having a manual override for moving the main control spool of the valve.

### BACKGROUND

Fluid control valves are used in a wide variety of applications for causing and controlling motion of various components. Hydraulic fluid control valves and systems are used in such applications when relatively large forces are to be transmitted and controlled through such components.

Hydraulic fluid control valves may include a housing having internal fluid passages, external ports, and spool bores with valve spools slidably disposed within each spool bore. The spool bores may include a main control valve spool bore in which a main directional control valve spool is slidably disposed to control hydraulic fluid flow between a hydraulic pump and a hydraulic motor. As used herein, the term “hydraulic motor” means any rotary or linear hydraulic device that is actuated by hydraulic fluid under pressure, such as, for example, a hydraulic cylinder or rotary actuator or gerotor motor or other hydraulic motor.

In such valves, the main valve control spool may be moved by a fluid pilot actuator or by an electric actuator or by other type of actuators. To operate the main valve control spool in the event the fluid pilot actuator or electric actuator or other actuator malfunctions or is otherwise not available, a manual override may be provided. Such manual overrides may include a manual override lever pin having spaced-apart end regions. One of the end regions may be secured to a rotatable manual override shaft, and the other end region may be connected to the control spool. When the manual override shaft is rotated, the manual override lever pin rotates about a lateral axis with the manual override shaft and moves the main valve control spool.

### SUMMARY OF INVENTION

Conventional hydraulic control valve manual overrides of this type typically connect the manual override lever pin to the manual override shaft with a threaded connection. To secure the threaded connection, a thread locking compound such as that sold under the trademark Loctite may be applied to the threads during assembly. To improve this threaded connection, exemplary embodiments provide a mechanical antirotation element such as an interference locking thread profile, e.g., the profile identified by the trademark Spiralock®.

According to one aspect of the invention, a manual override for a hydraulic control valve spool includes a rotatable shaft having a threaded hole; a lever pin having a first end connected for movement with a hydraulic control valve spool and a second end having an external thread that is threadably received in the threaded hole; and the threaded hole and external thread include a mechanical antirotation element.

Optionally, the mechanical antirotation element includes an interference threaded connection.

Optionally, the threaded hole includes an interference thread form.

Optionally, the threaded hole includes a Spiralock® thread form.

According to another aspect, a hydraulic control valve includes a valve body; a hydraulic control valve spool bore; a hydraulic control valve spool bore disposed in the bore; a rotatable shaft having a threaded hole; and a lever pin rotatable with the rotatable shaft, the lever pin having a first end connected for movement with the hydraulic control valve spool and a second end having an external thread that is threadably received in the threaded hole of the rotatable shaft. The threaded hole and external thread provide an interference threaded connection.

Optionally, the threaded hole includes an interference thread form.

Optionally, the threaded hole includes a Spiralock® thread form.

The foregoing and other features of the invention are hereinafter described in greater detail with reference to the accompanying drawings.

### BRIEF DESCRIPTION OF THE DRAWINGS

FIG. 1 is a lateral cross sectional view of a preferred embodiment of a manual override for a main control valve spool according to the present invention.

### DETAILED DESCRIPTION

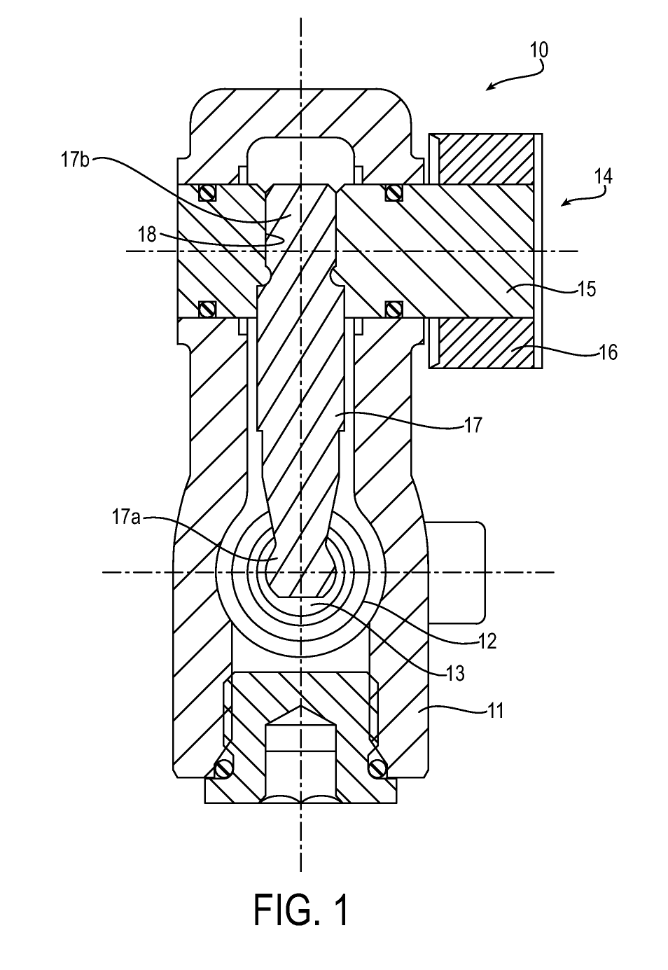

Referring now to the drawings in greater detail, FIG. 1 illustrates a hydraulic control valve 10 that includes a cast and machined metal housing 11. The housing 11 includes a longitudinally extending main control valve spool bore 12, and a main control valve spool 13 is slidably disposed in the bore 12. The main control valve spool is movable between various positions, such as, for example between a center or off position to block hydraulic fluid flow to work ports (not shown) and actuated displaced positions to control hydraulic fluid flow to the work ports. This movement of main valve control spool 13 may be controlled by a conventional actuator such as, for example, a hydraulic pilot actuator or an electric actuator or other suitable actuator.

The valve 10 also includes a manual override 14 that operates to control movement of the main valve control spool 13 in the event the actuator malfunctions or is otherwise unavailable. The override 14 includes a rotary shaft 15 that is rotatably journaled in the housing 11 and a lever 16 that may be grasped to manually rotate shaft 15. A generally cylindrical lever pin 17 has one end 17a secured to the main valve control spool 13 in a suitable manner such as, for example, by a ball and socket connection with the ball being integrally formed on the one end 17a and the socket (not shown) being formed on the control valve spool 13. The other end 17b of the lever pin 17 is threaded and is threadably connected to a threaded lateral hole 18 in rotary shaft 15.

If after assembly and during operation the lever pin 17 were to rotate about its longitudinal axis relative to shaft 15 and begin to unthread its threaded end 17b from threaded hole 18, the lever pin 17 may jam relative to the main valve control spool 13 and interfere with or prevent movement of main valve control spool 13. To prevent this, an interference thread is provide for the threaded hole 18 of shaft 15. The interference thread may preferably be a thread form identified by the trademark Spiralock® for the threaded hole 18, which provides a female thread form with a 30 degree ramp on its major diameter and gives a free running assembly until it is torqued and the major diameter of the threaded end 17b engages this ramp and provides a secure lock. To assure proper plastic deformation of the thread form of the threaded hole 18 as the lever pin 17 is torqued into threaded hole 18, manual override lever pin 17 is significantly harder than the shaft 15. In the preferred embodiment, the lever pin 17 is a medium carbon steel such as cold drawn AISI 1141 steel with a hardness in the range of about 48-52 Rockwell C, while the shaft 15 is a non-heat treated as drawn AISI 316 stainless steel.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A manual override for a hydraulic control valve spool comprising:
a rotatable shaft having a threaded hole;
a lever pin having a first end connected for movement with a hydraulic control valve spool and a second end having an external thread that is threadably received in the threaded hole;
and the threaded hole and external thread include a mechanical antirotation element.

2. A manual override as set forth in claim 1, wherein the mechanical antirotation element includes an interference threaded connection.

3. A manual override as set forth in claim 1, wherein the threaded hole includes an interference thread form.

4. A manual override as set forth in claims 1, wherein the threaded hole includes a Spiralock thread form.

5. A hydraulic control valve comprising:
a valve body;
a hydraulic control valve spool bore;
a hydraulic control valve spool bore disposed in the bore;
a rotatable shaft having a threaded hole; and
a lever pin rotatable with the rotatable shaft, the lever pin having a first end connected for movement with the hydraulic control valve spool and a second end having an external thread that is threadably received in the threaded hole of the rotatable shaft,
wherein the threaded hole and external thread provide an interference threaded connection.

6. A hydraulic control valve as set forth in claim 5, wherein the threaded hole includes an interference thread form.

7. A hydraulic control valve as set forth in claim 5, wherein the threaded hole includes a Spiralock thread form.
